(19) United States
(12) Patent Application Publication
(10) Pub. No.: US 2021/0040688 A1
(43) Pub. Date: Feb. 11, 2021

(54) METHOD OF PRODUCING DISSOLVING PULP

(71) Applicant: ANDRITZ OY, Helsinki (FI)

(72) Inventors: Auvo KETTUNEN, Kotka (FI); Sampsa LAAKSO, Helsinki (FI); Tiina HAATAINEN, Varkaus (FI); Markus PAANANEN, Helsinki (FI)

(21) Appl. No.: 16/978,462

(22) PCT Filed: Mar. 6, 2019
(86) PCT No.: PCT/FI2019/050176

§ 371 Date: Sep. 4, 2020

(30) Foreign Application Priority Data
Mar. 7, 2018 (FI) 20185213

(51) Int. Cl. D21C 3/02; D21C 9/10; D21C 9/06; D21C 9/00; D21C 1/04

(52) U.S. Cl. CPC D21C 3/02; D21C 9/10; D21C 1/04; D21C 9/004; D21C 9/06

(57) ABSTRACT

A process for producing dissolving pulp from comminuted wood-based fibrous material. The process includes the following consecutive stages: cooking comminuted fibrous material with alkaline cooking liquor in a kraft cooking process to produce pulp; treating the cooked pulp in caustic extraction at a temperature of 70-110° C. and in an effective alkali concentration of 60-120 g/l for at least 5 minutes, and washing and oxygen delignifying the caustic extracted pulp.

The present invention relates to a method for producing dissolving pulp.

In recent years, a strong need has emerged to develop new fibrous raw materials for the needs of the textile industry and other polymer industry. One solution for producing fibers is to increase the production of dissolving pulp, so that viscose fibers partly replace cotton in the textile industry, but they also have several other applications.

Dissolving pulp differs from the pulp intended for paper production in terms of properties and chemical composition. The production of dissolving pulp strives to create pulp with the highest possible cellulose concentration and the lowest possible concentration of hemicellulose, such as xylan, while striving to remove lignin from bleached paper pulp during the cooking and bleaching in such a way that as much cellulose and hemicellulose as possible remains in the paper pulp. In addition to the main component, cellulose—which is described as α-cellulose—paper pulp can contain up to 25% of hemicellulose, while dissolving pulp always contains over 90% of a-cellulose, and the amount of hemicellulose must typically be about under 5%.

The low hemicellulose concentration of dissolving pulp is typically sought by treating chips and/or pulp under strongly alkaline and acidic conditions. Dissolving pulp has conventionally been made either with a sulfite process or with a sulfate process equipped with acid prehydrolysis. If the sulfate process was used in the production of dissolving pulp, before alkaline cooking, wood chips were subjected to prehydrolysis, where a significant amount of hemicellulose was removed under acidic conditions before the alkaline cooking. The intensity of the pre-treatment is indicated by the P factor, which in the sulfate process equipped with prehydrolysis normally varies from 500 to 1,000 depending on the type of wood. The concept of the P factor is explained, for example, in Handbook of Pulp, Sixta, H. (ed.), Vol. 1, 2006, p. 343-345.

$$P = {\int }_{{t}_{0}}^{t} {k}_{rel} \cdot dt$$

where kᵣₑₗ is the relative rate of acid-catalyzed hydrolysis and is dependent on temperature, and

t equals time.

At the end of the fiberline, pulp is processed in bleaching stages similar to paper pulp, where the most important difference is the alkaline bleaching stages, which are carried out at higher temperatures than in maximum yield-preserving bleaching. Furthermore, in order to produce viscose pulp, both sulfate cooking and sulfite cooking have typically cooked to a lower kappa than in paper pulp production.

As described above, typically in dissolving pulp production, caustic extraction is carried out after an acidic cooking process, or the chips are subjected an acid pre-hydrolysis stage at a high temperature and pressure before alkaline cooking. Cooking chips under acidic conditions is more demanding than under alkaline conditions. Acidic conditions require better materials, and there is greater wear on the equipment without the lubricating effect of alkali. For this reason, it would be advantageous to be able to produce dissolving pulp without cooking chips under acidic conditions or while using the mildest possible acid treatment. Another problem with acid treatment can be that, in addition to the removal of hemicellulose, acid treatment also leads to a decrease in the cellulose yield and, consequently, the stronger the acid treatment, the lower the pulp yield typically is.

In softwood, hemicellulose mainly consists of glucomannan and xylan. The hemi-cellulose of hardwood consists almost entirely of xylan. Xylan typically dissolves under strongly alkaline conditions.

The amount of cooking chemical involved in cellulose cooking is indicated in pulp production with the term “effective alkali”. The effective alkali concentration value describes the hydroxide ion (OH) concentration of cooking liquor. In this application, effective alkali (g/l) is stated as NaOH.

One fairly effective method for dissolving hemicellulose from the post-cooking pulp is caustic extraction, where cooked pulp is treated with alkali. The treatment method is either cold caustic extraction or hot caustic extraction. In cold caustic extraction, effective alkali concentration is at the level of 60-110 g/l and the temperature is typically at the level of 20-50° C. The other method used is hot caustic extraction, where the effective alkali concentration is typically at the level of 4-20 g/l and the temperature is 80-140° C. These processes are extensively dealt with in Rydholm, S., Pulping Processes, 1967, p. 992-1023. The efficiency of hot caustic extraction is significantly lower than that of cold caustic extraction, and it is generally only used in the context of acid sulfite cooks. In industrial processes, the low temperature of cold caustic extraction is inconvenient because it requires extra cooling and because it is significantly more difficult to wash cold pulp due to its poorer filterability. As is well known, caustic extraction can be done with concentrated sodium hydroxide solution or the white liquor used in cooking. For example, patent application WO 2013/178608 presented a solution with which pulp produced with the normal alkali concentrations of kraft cooking can be used to produce dissolving pulp using caustic extraction, which is done at 65° C. or lower temperatures. In this solution, cold caustic extraction is carried out after the cooking and oxygen stage, and the residual chemicals of caustic extraction are utilized during the oxygen stage and on a parallel cooking line. In the process, xylan-rich alkali solution can be used for cooking on a parallel line. One difficulty of this solution is that the residual sulfide of white liquor needs to be oxidized with chemicals before acid treatment of the pulp to prevent the formation of dangerous hydrogen sulfide. The acid treatment can be, for example, the first bleaching stage.

The purpose of the present invention is to eliminate the aforementioned problems and provide a method where the residual alkali of caustic extraction can be utilized in cooking in the same fiberline without significant xylan reabsorption and where the acidic conditions of dissolving pulp production can be mitigated compared to production of dissolving pulp without caustic extraction.

Unexpectedly, it has been observed in experiments that xylan also dissolves selectively from cooked unbleached pulp at higher temperatures at the level of 70-110° C., when the effective alkali concentration is at the level of 60-120 g/l. The higher the alkali concentration, the more xylan can be dissolved. Therefore, caustic extraction done at higher temperatures can also be used to remove significant amounts of hemicellulose from hardwood pulp. Conversely, it has been observed that the other significant hemicellulose component of softwood, glucomannan, does not significantly dissolve under these conditions.

A new method for producing dissolving pulp from comminuted hardwood-based fibrous material, which method comprises the following consecutive steps:
treating comminuted fibrous material under acidic conditions such that a P factor of 5-250 is achieved;
cooking comminuted fibrous material with alkaline cooking liquor in a kraft cooking process to produce pulp;
treating the cooked pulp in caustic extraction at a temperature of 70-110° C. and with an effective alkali concentration of 60-120 g/l for at least 5 minutes,

washing the caustic extracted pulp, and

oxygen delignifying the caustic extracted pulp.

In the solution according to the invention, which is suited to continuous cooking, in particular, but also applicable to batch cooking, caustic extraction is combined with kraft cooking, which facilitates achieving a low xylan concentration in the pulp more efficiently than in known processes. Caustic extraction is done between the cooking and the oxygen stage, allowing the residual alkali from caustic extraction to be utilized at the same digester plant with simple connections. Filtrate which is separated from the caustic extracted pulp, has an effective alkali concentration of at least 50 g/l, typically 60-110 g/l, and is led to the cooking. The filtrate is separated with, for example, a press or fractionating washer, where the aim is to achieve the most concentrated filtrate possible in terms of alkali. A fractionating wash can be used to enhance alkali accumulation and increase alkali concentration during the caustic extraction stage. When the washing stage preceding the caustic extraction, such as a digester wash, is supplied with wash liquor with the highest possible alkali concentration, the alkali concentration of the pulp coming from the washing stage increases. A higher alkali concentration is then achieved after white liquor is added, resulting in even more concentrated wash liquor for the wash stage preceding caustic extraction. In the fractionating wash, after caustic extraction, the more dilute filtrate is delivered to the cooking and, therefore, cannot dilute the caustic extraction. At the same time, the alkali concentration in the final stage of the cook is high, which minimizes xylan reabsorption during pulp cooking.

The method according to the invention comprises, according to one preferable embodiment, the following consecutive steps:

a) treating comminuted fibrous material under acidic conditions such that a P factor of 5-250 is achieved; b) cooking the fibrous material with alkaline cooking liquor at a cooking temperature of about 120-175° C. to produce pulp, c) feeding alkaline wash liquor into the pulp to cool and/or wash it before discharging the pulp from the cooking; d) feeding white liquor to and mixing it with the cooked pulp, e) treating the pulp at 70-110° C. for 5-120 minutes; f) removing the first filtrate from the pulp after step e), which produces a filtrate that is delivered for use as pulp wash liquor counter-currently to the pulp flow; and g) separating a second filtrate from the pulp after step e), which filtrate is delivered to step b) to constitute at least a portion of the cooking liquor; and h) delivering the pulp to an oxygen stage and further processing after step g).

In step a), acidic waste cooking liquor forms; it can be extracted from the fibrous material, if necessary. In step d), white liquor can be supplied to the pulp at the bottom of the digester or into the pulp removed from the digester.

The aim in steps f) and g) is to remove at least two filtrates from the pulp, with the first filtrate having the highest possible effective alkali concentration. A filtrate with a high effective alkali concentration, at least 50 g NaOH/l, is first separated from the pulp. This filtrate is used as pulp wash liquor counter-currently to the pulp flow in step c). A second filtrate is also separated from the caustic extracted pulp, with a lower alkali concentration than the first filtrate. This filtrate is used in the digester as a source of alkali and added to step b). The first filtrate can be, for example, a filtrate produced during a fractionating washer's thickening stage, which thereby contains liquid phase separated from the caustic extracted pulp. The second filtrate is typically a filtrate produced during the wash stage. Filtrates can form in the same piece of equipment, such as a fractionating washer or a consecutive press and wash press. Other arrangements are also possible. Caustic extraction can also be done without a fractionating wash. The advantage of a fractionating wash is that it helps achieve a higher alkali concentration and more efficient hemicellulose removal.

The pulp is not oxygen delignified before the caustic extraction stage. When caustic extraction is done before the possible oxygen stage, transformation of residual sulfide to hydrogen sulfide in the acidic stages after the caustic extraction and oxygen stage does not take place.

The oxygen delignification stage is an alkaline stage known per se, which typically occurs pressurized and where oxygen is present around the fibers for at least a portion of the reaction time. The oxygen stage can have one, two or more steps, in which case the reaction step includes chemical mixing and a reaction vessel or a reaction delay accomplished by a tube. Usually, oxygen and alkali and possibly an inhibitor to prevent metals from damaging fibers are dosed into the oxygen stage, or metals entrained in the fibers are removed or made unreactive through other means.

In one embodiment, the cooking stage is carried out in a continuous single or two vessel hydraulic or vapor phase digester. The method can be carried out in one or more cooking vessels, for example with a combination of a digester and a prehydrolysis vessel.

In one embodiment, the cooking stage is carried out as a batch digester process.

Dissolved xylan enters the cooking with the caustic extraction filtrate. When a sufficiently high effective alkali concentration, at least 20 g NaOH/l, is maintained in the cooking, dissolved xylan from caustic extraction does not precipitate in harmful quantities in the fibrous material, such as chips, near the end of the cook. The first part of the cooking can have a lower alkali concentration, in which case some xylan can precipitate, because precipitated xylan dissolves again once the alkali concentration of the cooking has risen to a high level.

In the solution according to the invention, all or most, at least 60%, typically at least 80%, most preferably over 90% of the white liquor needed for the cooking is supplied and mixed into the brown stock caustic extraction after the cooking. Caustic extraction is carried out between the cooking and oxygen stage in a temperature range of 70-110° C., preferably 80-100° C. White liquor can be used as a source of alkali in caustic extraction. The effective alkali concentration of the white liquor is 90-130 g/l NaOH, typically 100-120 g/l. According to the new solution, fresh cooking liquor, i.e. white liquor, is not brought in at all, or no more than 40%, typically under 20%, is brought in to the digester or the cooking stage itself.

The filtrate(s) of pulp thickening and/or washing after caustic extraction is/are run counter-currently to the pulp flow towards the digester or digester plant. The white liquor thereby supplied accumulates in these circulations, which helps achieve the alkali concentrations required for caustic extraction. In other words, alkali accumulates between the pulp thickening and/or washing after the digester wash and caustic extraction when the filtrates are circulated counter-currently. The required alkali concentration level is thus achieved even though the pulp consistency is typically 8-12%.

White liquor and filtrates can be treated as needed to achieve the temperature level required for caustic extraction, which is 70-110° C., preferably 80-100° C. On an industrial scale, the temperature is typically 70-95° C. The treatment time in caustic extraction is over 5 minutes, typically 5-120 minutes. In caustic extraction, the effective alkali concentration of the pulp suspension's liquid phase is 60-120 g/l, preferably 65-110 g/l, most preferably 70-110 g/l. Some of the alkali-rich filtrates of the pulp washer(s) are conveyed to the cooking stage, while some are supplied to the end of the cooking stage, for example at the bottom of the digester. It is essential that all or nearly all filtrates, at least 80%, circulate through the digester, because otherwise valuable chemicals would be lost with filtrate that is run past the digester to the evaporation plant. The alkali-rich black liquor obtained from the cooking stage, which has an effective alkali concentration of over 20 g NaOH/l, is circulated onward to the beginning of the cooking process, where the alkali is consumed, achieving a normal residual alkali level, under 10 g NaOH/l, in the black liquor taken to the evaporation plant.

According to an essential characteristic of the new method, the pulp is not oxygen delignified between the cooking and caustic extraction. After caustic extraction, the pulp is taken to further processing, which typically includes an oxygen stage to start with. When caustic extraction is done before the oxygen stage, the pulp's residual sulfide becomes oxidized during the oxygen stage and there is no risk of hydrogen sulfide formation during the acidic treatments that come after the oxygen stage.

The pulp can be processed further in bleaching stages, which can include, for example: acidic stages A, Z and D as well as alkaline stages E and P. During the further processing stages, the xylan concentration in the pulp can be further reduced. Xylan removal can be enhanced preferably in the acid stage, the A-stage , where the temperature can be 100-130° C. and the pH 2-3. The A-stage is carried out after the caustic extraction stage and preferably after the oxygen stage.

In the solution according to the invention, hemicellulose removal can also be enhanced with acid treatments, for example using a normal prehydrolysis stage or various acid pulp treatments. The solution according to the invention can be advantageously combined with a light acid treatment before cooking, where the P factor in acid hydrolysis is 5-250 and a portion of the hemicellulose contained by the wood dissolves. This kind of acid treatment can be done in a prehydrolysis vessel, as is normally done when using the prehydrolysis sulfate cooking process, but with a lower temperature or shorter delay than usually. The acid treatment can also be done in the top section of the cooking vessel in either vapor or liquid phase. In a continuous digester plant, chips are typically steamed in a chip bin that is at atmospheric pressure and has a delay of about 10-45 minutes. A light acid treatment can be generated by pressurizing the chip bin to a pressure of about 1-10 bar, at which point the steaming temperature can be raised to over 120° C. and hydrolysis reactions start occurring. The aim in the chip bin is a P factor value of 5-50. Preferably, the chip bin pressure level could be about 2 bar and the temperature about 135° C., at which point the atmospheric chip bin only requires minor changes and chips can be supplied into the bin with a low pressure feeder. When the hydrolysis treatment is done in the chip bin in vapor phase, actual chip feeding to the digester can take place under alkaline conditions, avoiding wear to bin-external chip feed equipment due to acidic conditions. Condensate that forms during vapor-phase hydrolysis can be recovered and circulated back into the chips entering the bin, which reduces the chip pH more quickly and accelerates hydrolysis reactions.

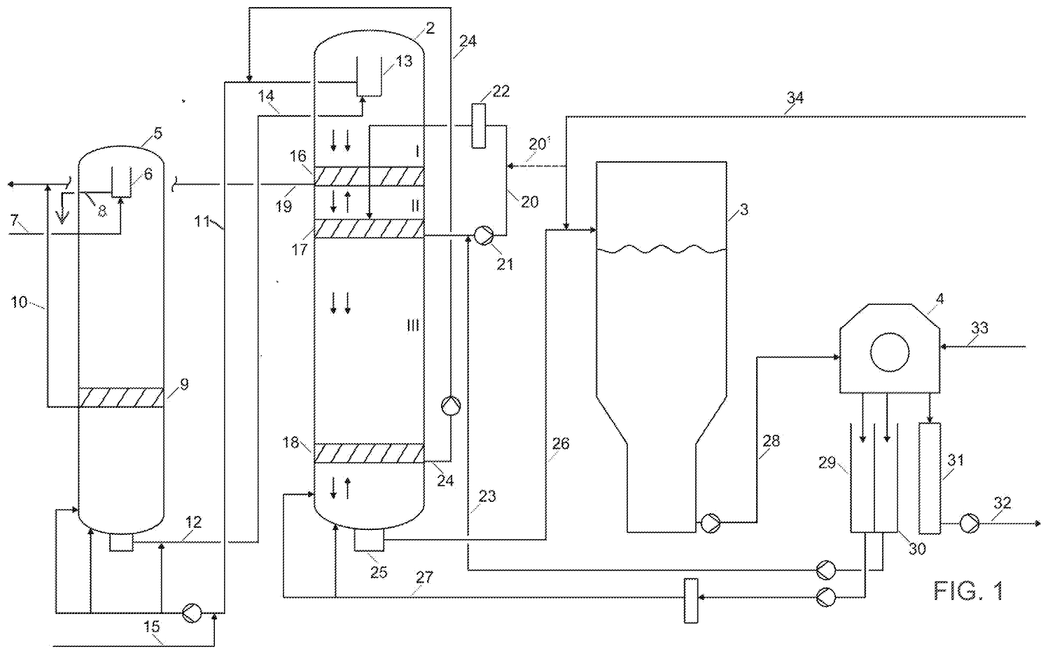

The new method is explained in more detail with reference to the drawing provided, where one embodiment of the invention is illustrated schematically in FIG. 1.

FIG. 1 presents a typical system with which the new method can be implemented. The system comprises at least a cooking vessel 2, caustic extraction vessel 3 and washer 4. The digester 2 is a vapor phase digester, but it can also be a hydraulic digester. The method can be carried out in one or more cooking vessels, for example with a combination of a digester and a prehydrolysis vessel. Especially in an arrangement with several cooking vessels, the implementation of the method can deviate from the details described here, but the same operating principles apply. The system also includes a hydrolysis reactor 5, which has a top separator 6, which receives comminuted hardwood-based fibrous material suspension, such as chip slurry, from the chip supply system (not shown) via line 7.

The prehydrolysis vessel 5 can be a vapor phase reactor or hydraulic vessel, which has a heating circulation for heating the material to the desired hydrolysis temperature.

The supply material is delivered to an inverted top separator 6 at the top of the vessel 5. The top section of the vessel can be a vapor phase zone, through which the fibrous material falls from the top separator 6 to the surface of a column of liquid and chips. In the top separator, liquid is separated from the fibrous material and passed to the chip supply system via line 8. Steam and pressurized air can be introduced to create a suitable pressure and temperature for hydrolysis. The temperature of the fibrous material is raised above the autohydrolysis temperature, which can be over 140° C., for example 155° C., and maintained at this temperature to promote hydrolysis. The aim is a P factor value of 5-250, which dictates the conditions. Autohydrolysis takes place when organic acids are released from fibrous material. The hydrolysis temperature might be under 150° C., for example between 150 and 120° C., if dilute acids are added. The fibrous material and liquid flow co-currently downwards in the vessel 5. The hydrolysate formed can be removed through screens 9 to line 10 and taken to further processing.

At the bottom of the hydrolysis vessel 5, dilution liquor is added to the fibrous material from the cooking vessel 2 via line 11 to assist with the transportation of the fibrous material via line 12 to the digester's 2 top separator 13. The dilution liquor in the return line 11 is alkaline, so it makes the fibrous material alkaline when the material flows from the prehydrolysis vessel to the digester 2. Reject from the black liquor filter can be introduced to line 11 via line 15; the reject contains fibers and undigested fibrous material.

The fibrous material is in an alkaline state, such as at pH 13 or close to it, for example at 12-14. As an example, fibrous material can be kept in the digester in a temperature range of 120-175° C., or 130-160° C., depending on, for example, the residence time and alkali concentration in the digester. In such cases, the H factor is 100-500, typically 200-300.

The temperature in the digester 2 is raised and controlled by adding steam and possibly air or inert gas. The digester can be a vapor-phase or hydraulic full vessel. The pressure at the bottom of the hydrolysis vessel is a combination of steam pressure and the hydraulic pressure of the column of fibrous material and liquid. This combined pressure is higher than the pressure at the top of the digester. This differential pressure transports the fibrous material via line 12,14 to the digester's top separator. Furthermore, when the digester is a hydraulic cooking vessel, heating liquor circulation can be used to heat the fibrous material to a desired temperature.

The digester can include several co-current and counter-current cooking zones. The topmost cooking zone can be a co-current zone of fibrous material and liquor.

The digester comprises screens 16, 17 and 18. The fibrous material is processed with cooking liquor in zone I. The temperature in zone I, which is controlled by feeding steam, is, for example, 144° C. The effective alkali concentration of the supplied cooking liquor is typically 20-50 g NaOH/l, which is consumed in zone I such that the effective alkali concentration of the waste cooking liquor removed via screen 16 is less than 10 g NaOH /l, for example 4 g NaOH/l, and its temperature is, for example, 151° C. The waste cooking liquor of zone I is conveyed via line 19, typically to the evaporation plant.

Cooking zone I is followed by counter-current cooking zone II, which is between screens 16 and 17. Although the treatment has been shown as counter-current, it can also be co-current. At the end of zone II, waste cooking liquor is extracted into circulation 20, which includes one or several screens 17, a pump 21 and an indirect heat exchanger 22. Cooking liquor is added to the material of circulation 20 via line 23. Most of the alkali dose required for the cooking, for example 50%, is added to the fibrous material suspension via line 23 to circulation 20. This causes a high effective alkali concentration, which is over 25 g NaOH/l, preferably over 35 g/l, in the digester. The heated circulation 20 typically heats the fibrous material suspension and its cooking liquor to the cooking temperature, which is typically 120-175° C., before the suspension flows to the co-current cooking zone III. The cooking liquor added via conduit 23 in order to achieve a high alkali concentration and high pH can have the following characteristics: total alkali on wood about 8-16%, effective alkali concentration about 40-80 g/l (typically about 50-70 g/l) measured as NaOH, and a flow of about 2.0-6.0 m³/BDMT (m³/bone dry metric tons) of pulp, typically about 3.0-5.0 m³/BDMT of pulp. The effective alkali concentration of the cooking liquor of line 23 is, for example, 58 g NaOH/l, and its temperature, for example, 94° C.

If necessary, white liquor can be delivered to circulation 20 via line 20′.

The fibrous material travels at cooking temperature in digester zone III co-currently downwards as the cooking reaction progresses. In the lower part of the digester, hot waste cooking liquor is now extracted from the cooked fibrous material, such as chips, with a screen assembly 18. Washing filtrate from a pulp washer situated further along is supplied to the bottom of the digester via one or more conduits 27 to end the cooking reaction and to reduce the temperature of the cooked chip slurry.

The pulp is then removed from the digester via a discharge device 25 to conduit 26.

The hot waste cooking liquor is extracted from the digester via a screen assembly 18 and conduit 24. The hot liquor has a relatively high fresh alkali concentration, i.e. residual alkali concentration. The effective alkali concentration of the liquor in conduit 24 is typically at least 20 g/l, preferably at least about 25 g/l, for example 41 g/l. This liquor, which contains both alkali and sulfide, is delivered via conduit 24 to return line 11 for use in the pre-treatment of the supplied chips or in zone I. The temperature of the liquor in conduit 24 can be, for example, 143° C.

The cooked pulp is delivered via line 26 to caustic extraction in vessel 3. Vessel 3 can be a conventional digester blow tank or another type of vessel. The effective alkali concentration of the pulp leaving the digester is 60-110 g NaOH/l, for example 91 g/l, and its temperature is 70-110° C., for example 102° C. The white liquor needed for the cooking process and caustic extraction from line 34 is supplied and mixed with the pulp flowing in line 26. The effective alkali concentration of the white liquor is 90-130 g/l NaOH, typically 100-120 g/l, for example 115 g/l. Caustic extraction is done at a temperature of 70-110° C., for example 90° C. The temperature of the pulp discharged from the digester can be adjusted by adjusting the temperature of the washing filtrates added to it at the bottom of the digester. The duration of caustic extraction is 5-120 minutes.

The caustic extracted pulp is taken from vessel 3 via line 28 to the pulp thickener or washer 4, which can be, for example, a press, wash press or fractionating washer, and of which there can be one or several. Water or filtrate from the oxygen stage or bleaching stage is delivered to the washer for wash liquor via line 33. The aim is to separate at least two filtrates from the pulp, with the first filtrate having a high effective alkali concentration. The first filtrate can be a filtrate produced during the fractionating washer's thickening stage, which thereby contains liquid phase separated from the caustic extracted pulp. The second filtrate is typically a filtrate produced during the wash stage. Filtrates can form in the same piece of equipment, such as the fractionating washer or a consecutive press and wash press.

A filtrate with a high effective alkali concentration, for example 94 g NaOH/l, is first separated from the pulp. This filtrate from the filtrate tank 29 is used as wash liquor at the bottom of the digester, which helps achieve the highest possible caustic extraction concentration level. The digester's wash zone is counter-current, where the alkali-rich wash liquor of line 27 displaces cooking liquor of cooking zone Ill via screen 18 out of the digester and continues with the pulp to caustic extraction in vessel 3.

The more dilute filtrate obtained from the pulp is used in the digester as a source of alkali and taken from the filtrate tank 30 via line 23 to circulation 20, through which it is added to the cooking zone. Most of the alkali dose required for the cooking, at least 50%, is added to the fibrous material suspension via line 23 and circulation 20.

The filtrates contain xylan that was separated from the fibrous material during caustic extraction. Because a sufficiently high effective alkali concentration, at least 20 g NaOH/l, is maintained near the end of the cook, dissolved xylan from caustic extraction does not precipitate in harmful quantities in the fibrous material, such as chips, during the cooking.

The filtrate of line 23 can be heated with the heat of waste cooking liquors 24 and/or 19 extracted from the digester by arranging an indirect heat exchanger (not shown) for the lines.

The pulp is removed from the washer 4 via dropleg 31 and line 32 to further processing, which typically includes an oxygen stage, to begin with. The pulp can be processed further in bleaching stages, which can include, for example: acidic stages A, Z (ozone) and D (chlorine dioxide) as well as alkaline stages E (extraction) and P (peroxide). During the further processing stages, the xylan concentration in the pulp can be further reduced.

Xylan removal can be further enhanced preferably in the acid stage, the A-stage, where the temperature can be 100-130° C. and the pH 2-3. The A-stage comes after the caustic extraction stage and preferably after the oxygen stage.

### EXAMPLE 1

A method according to the invention was analyzed in a laboratory. The raw material was hardwood chips with a xylan concentration of 12.1%. When the chips were cooked in a normal alkali profile, the cooking yield was 53.3% at kappa number 17.1 and the xylan concentration in the pulp was 14.5%, meaning that 62% of the original xylan in the chips remained.

When the chips were cooked in a higher alkali concentration according to the method, the cooking yield was 50.4% at kappa number 14.5 and the xylan concentration in the pulp was 12.3%, meaning that 50% of the original xylan in the chips remained. When this pulp was caustic extracted at a temperature of 50° C., it produced pulp with a kappa number of 8.7 and a xylan concentration of 5.0%. Thus, only 16% of the original xylan in the chips remained. When the temperature of the corresponding caustic extraction was 90° C., the pulp's kappa number was 8.8 and its xylan concentration was 5.9%, and 20% of the original xylan in the chips remained. The laboratory tests show that both pulps can be used as dissolving pulp, especially after appropriate further processing and/or pre-treatments, and that caustic extraction can also be carried out quite successfully in the normal brown stock wash temperature range of 70-100° C., and that high alkali profile cooking creates a better than normal starting point for successful caustic extraction.

### EXAMPLE 2

A method according to the invention was analyzed in a laboratory. The raw material was hardwood chips with a xylan concentration of 15.5%. When a prehydrolysis stage with 200 P factors was first carried out for the chips, along with a cooking stage in a high alkali concentration, the cooking yield was 44.2% at kappa number 10.2 and the xylan concentration in the pulp was 5.5%. Thus, 16% of the original xylan in the chips remained. When this pulp was caustic extracted at a temperature of 90° C. and an alkali concentration of about 80 g/l, it produced pulp with a kappa number of 6.9 and a xylan concentration of 2.6%. The total yield after prehydrolysis, cooking and caustic extraction was 42.3%. Thus, only 7% of the original xylan remained. When the same raw material was used in the laboratory to produce dissolving pulp using conventional prehydrolysis cooking with 500 P factors, the yield was 39.4%, the kappa was 6.6 and the xylan concentration in the pulp was 2.5%. These laboratory tests show that, with caustic extraction, good-quality dissolving pulp can be produced with a significantly higher yield than when using the conventional prehydrolysis process.

Advantages of the new solution:

The method connects caustic extraction more simply and economically than previously to a cooking process in the same line because the cook's alkali profile avoids excess xylan precipitation in the chips. When caustic extraction is done before the oxygen stage, transformation of residual sulfide to hydrogen sulfide in the subsequent acidic stages does not take place. With caustic extraction in accordance with the method, the prehydrolysis stage can be lightened considerably, which significantly improves the pulp yield.

1. A method for dissolving pulp from comminuted hardwood-based fibrous material, the method comprises:
treating comminuted fibrous material under acidic conditions in which a P factor is in a range of 5 to 250;
cooking the treated comminuted fibrous material with an alkaline cooking liquor at a temperature in a range of 120° C. to 175° C. in a kraft cooking process to produce pulp;
treating the pulp in caustic extraction at a temperature is in a range of 70° C. to 110° C. for at least 5 minutes to produce caustic extracted pulp, wherein the caustic extraction includes a liquid phase in which the pulp is in suspension and an alkali concentration of the liquid phase is in a range of 60g/l to −120 g/l,
washing the caustic extracted pulp, and
oxygen delignifying the caustic extracted pulp after the washing.

2. The method according to claim 1, further comprising introducing white liquor with an effective alkali concentration of over 90 g/l to the pulp before the treatment of the pulp by the caustic extraction.

3. The method according to claim 1, further comprising separating filtrates from the caustic extracted pulp.

4. The method according to claim 1, further comprising extracting a first filtrate from the pulp after caustic extraction, and the first filtrate is delivered for use as pulp wash liquor flowing counter-currently to a pulp flow.

5. The method according to claim 4, further comprising separating a second filtrate from the pulp and delivering the second filtrate to the cooking step as at least a portion of the cooking liquor.

6. The method according to claim 1, further comprising treating the comminuted hard-wood based fibrous material in acid hydrolysis before the cooking step.

7. The method according to claim 1, wherein the temperature of the temperature of the caustic extraction step is in a range of 80° C. to 100° C.

8. The method according to claim 1, wherein during the caustic extraction step, the effective alkali concentration is in a range of 70 g/l to 110 g/l.

9. The method according to claim 3, wherein the pulp is treated in a fractionating wash to form the filtrates.

10. The method according to claim 4, wherein the first filtrate is delivered to a digester wash.

11. A The method according to claim 1, further comprising processing of the oxygen delignified caustic extracted pulp in an acid stage.

12. The method according to claim 1, wherein the cooking step is performed in at least one of: a continuous single hydraulic vessel, a two vessel hydraulic system, and a vapor phase digester vessel.

13. The method according to claim 1, the cooking step is performed as a batch digester process.

14. A method comprising:
a) treating comminuted fibrous material under acidic conditions in which a P factor is in a range of 5 to 250;
b) cooking the treated comminuted fibrous material with alkaline cooking liquor at a cooking temperature in a range of 120° C. to 175° C. to produce pulp,
c) feeding alkaline wash liquor to the pulp to cool and/or wash the pulp;
d) feeding white liquor to the pulp to form a mixture of the white liquor and the pulp, after step c;
e) treating the mixture of the white liquor and the pulp at a temperature of 70° C. to 110° C. for 5 to 120 minutes;
f) removing a first filtrate from the mixture and delivering the first filtrate as a pulp wash liquor flowing counter-currently to a pulp flow; and
g) separating a second filtrate from the mixture, and using the second filtrate as at least a portion of the alkaline cooking liquor; and
h) delivering the pulp to further processing after step g).

15. A method comprising:
treating comminuted hardwood based fibrous material under acidic conditions in which a P factor is in a range of 5 to 250;
producing pulp by a cooking the treated comminuted fibrous material with an alkaline cooking liquor at a temperature to a range of 120° C. to 175° C. in a kraft cooking process;
adding the pulp to a caustic extraction vessel in which the pulp is suspended in a liquid, controlling a temperature of the liquid with the suspended pulp is in a range of 70° C. to 110° C. for at least 5 minutes to produce caustic pulp, wherein an alkali concentration of the liquid with the suspended pulp is in a range of 60g/l to 120 g/l,
washing the caustic pulp after discharge from the caustic extraction vessel, and
oxygen delignifying the washed caustic pulp.

16. The method of claim 15, wherein the treatment of the comminuted hardwood based fibrous material is performed in a hydrolysis reactor, the cooking of the treated comminuted fibrous material is performed in a digester cooking vessel, and the caustic extraction vessel is a blow tank.
